(19) United States
(12) Patent Application Publication
(10) Pub. No.: US 2006/0043660 A1
(43) Pub. Date: Mar. 2, 2006

(54) Bar clamp

(75) Inventor: Qiu Jian Ping, Hangzhou (CN)

Correspondence Address: WILLIAM COLLARD;COLLARD & ROE, P.C., 1077 NORTHERN BOULEVARD, ROSLYN, NY, 11576, US

(73) Assignee: Great Neck Saw Manufacturers, Inc.

(21) Appl. No.: 10/932,433

(22) Filed: Sep. 2, 2004

(51) Int. Cl. B25B 1/00

(52) U.S. Cl. 269/6

(57) ABSTRACT

A bar clamp having a first jaw assembly, a second jaw assembly and a bar. The first and second jaw assemblies are mounted on the bar which is movable relative to the second jaw assembly. A trigger is operatively associated with the bar and is adapted to be activated to move the bar and the first jaw assembly relative to the second jaw assembly in one direction. A release mechanism on the second jaw assembly is operatively associated with the bar and is adapted to be activated in order to permit the bar and the first jaw assembly to move relative to the second jaw assembly in the opposite direction.

### BACKGROUND

This invention is an improvement over U.S. Pat. No. 6,338,475 dated Jan. 15, 2002 the entire contents of which are incorporated herein by reference.

The present invention relates to a bar clamp and more particularly to an improved ratchet type bar clamp in which the jaws may be moved toward each other step-by-step and the jaws maybe moved apart when desired.

Ratchet type bar clamps have been in use for a number of years. They usually comprise a jaw mounted on a moveable bar and another jaw mounted on a stationary handle assembly. A trigger is provided in the handle assembly which when pressed will move the jaws closer together in a series of steps. When it is desired to move the jaws apart, a release mechanism is activated to move the jaws apart. Existing ratchet type bar clamps are complicated and expensive to manufacture and assemble and may are not easily capable of being used with one hand.

### OBJECTS

The present invention overcomes these drawbacks and has for one of its objects the provision of an improved bar clamp which is simple to use.

Another object of the present invention is the provision of an improved bar clamp in which the jaw can be advanced toward each other with one hand.

Another object of the present invention is the provision of an improved bar clamp in which the jaws can be released by the same hand to move away from each other.

Another object of the present invention is the provision of an improved bar clamp in which the jaws can be easily placed in position to spread apart an article as well as to tighten on an article.

Another object of the present invention is the provision of an improved bar clamp which is simple and inexpensive to manufacture.

Other and further objects of the invention will be obvious upon an understanding of the illustrative embodiment about to described, or will be indicated in the appended claims and various advantages not referred to herein will occur to one skilled in the art upon employment of the invention in practice.

### BRIEF DESCRIPTION OF THE DRAWING

A preferred embodiment of the invention has been chosen for purposes of illustration and description and is shown in the accompanying drawings forming a part of the specification wherein:

Drawings

FIG. 1 is a perspective view of a bar clamp made in accordance with the present invention.

FIG. 2 is a side plan view thereof.

FIG. 3 is a sectional view taken along the line 3-3 of FIG. 2.

FIG. 4 is a sectional view taken along line 4-4 of FIG. 2.

FIG. 5 is a sectional view taken along line 5-5 of FIG. 2.

FIG. 6 is a sectional detail view showing the position of some of the parts when the jaws are to be moved toward each other.

FIG. 7 is a sectional detail showing the position of some of the parts when the jaws are to be moved away from each other.

FIG. 8 is a plan view showing the jaws moving toward each other.

FIG. 9 is a plan view showing the jaws moving away from each other.

FIG. 10 is a plan view showing the manner of switching one of the jaws to a position where the jaws are used to spread an item apart.

FIG. 11 is a plan view similar to FIG. 10 showing the jaws being moved apart from each other in an item spreading position.

FIG. 12 is s perspective detail view showing the manner of positioning the bar into one of the jaw bases.

FIG. 13 is a sectional view taken along line 13-13 of FIG. 10.

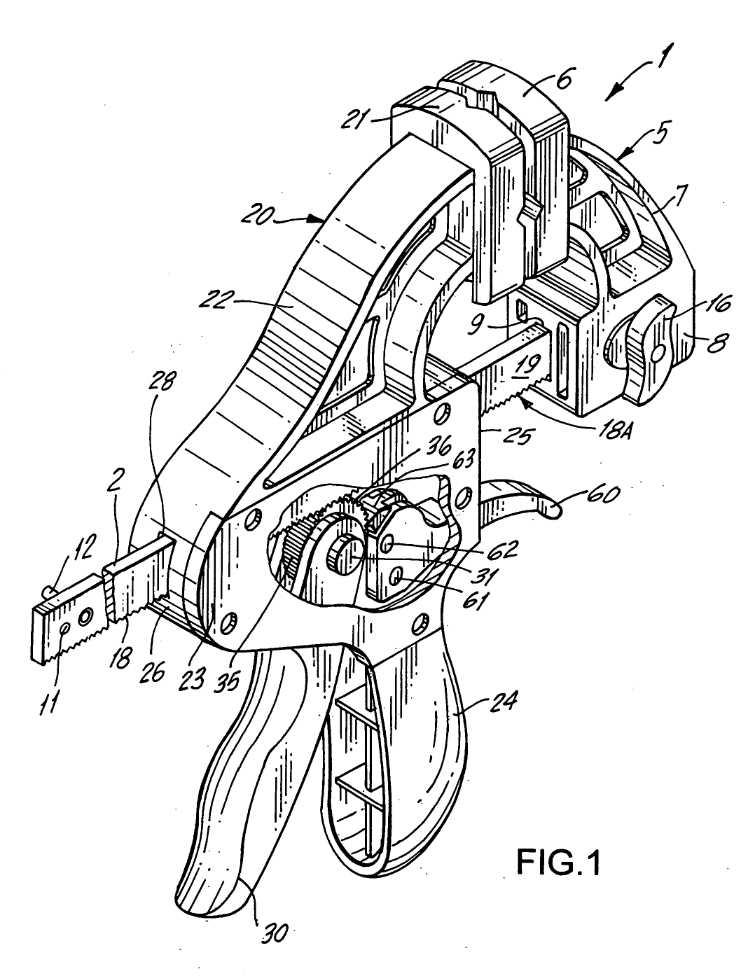

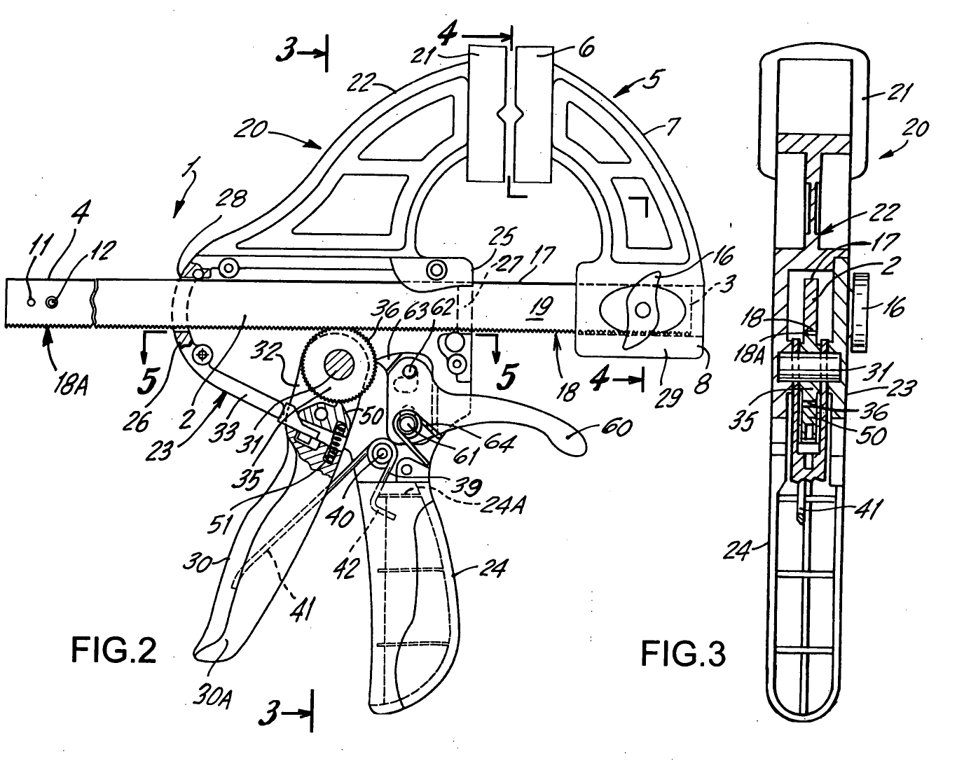

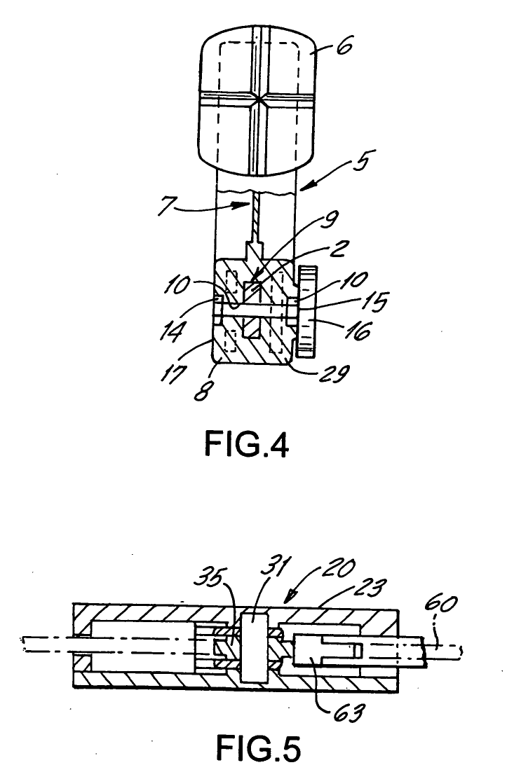

### DESCRIPTION

Referring to the drawings, the bar clamp 1 of the present invention comprises a straight bar 2 having a front end 3, a rear end 4, a top edge 17, a bottom edge 18 and side walls 19. The bottom edge 18 has a plurality of teeth 18A therein. The front and rear ends 3-4 each have an opening 11 therein and a guide pin 12 extending therefrom. Removably mounted on front end 3 is a first jaw assembly 5 which comprises a gripping face 6, a body 7, and depending a base 8. The base 8 has an opening 9 (FIG. 12) therein into which the front or rear end 3-4 of the bar 2 may be inserted. The guide pin 12 is adapted to slide in a groove 13 in opening 9 in the base 8 to guide the bar 2 into the opening 9 in the base 8. A side hole 10 extending from one face 29 of base 8 through to the other face 17. The side hole 10 has an inner end 14 and an outer end 15 both of which are coextensive and threaded. The jaw assembly 5 is held in place on the front end 3 of bar 2 by a threaded wing nut 16 inserted in the threaded ends 14 and 15 of the opening 10 in base 8 of the jaw assembly 5 and extending through the opening 11 in the bar 2.

A second jaw assembly 20 comprises a gripping face 21, a body portion 22 and a base portion 23 depending therefrom. The base portion 23 of the second jaw assembly 20 has a handle portion 24 extending downwardly therefrom. The base portion 23 is substantially hollow and has front and rear walls 25-26 with openings 27-28 therein which are in alignment with each other and through which the bar 2 extends. The base portion 23 has a trigger 30 which is pivotally mounted therein at 31 and which has an upper active head 32 extending into the base portion 23 through opening 33 at its bottom.

Within the hollow base portion 23 the active head 32 of the trigger 30 has a toothed rachet wheel 35 also mounted on pivot 31 and having a plurality of teeth 36 which mesh with the teeth 18A in the bottom edge 18 of the bar 2. A two leg spring 39 wound around pin 40 is provided and has one leg 41 bearing against the inner surface 30A of the trigger 30 and the other leg 42 bearing against an inner surface 24A of the handle 24 to bias the trigger 30 away from the handle 24.

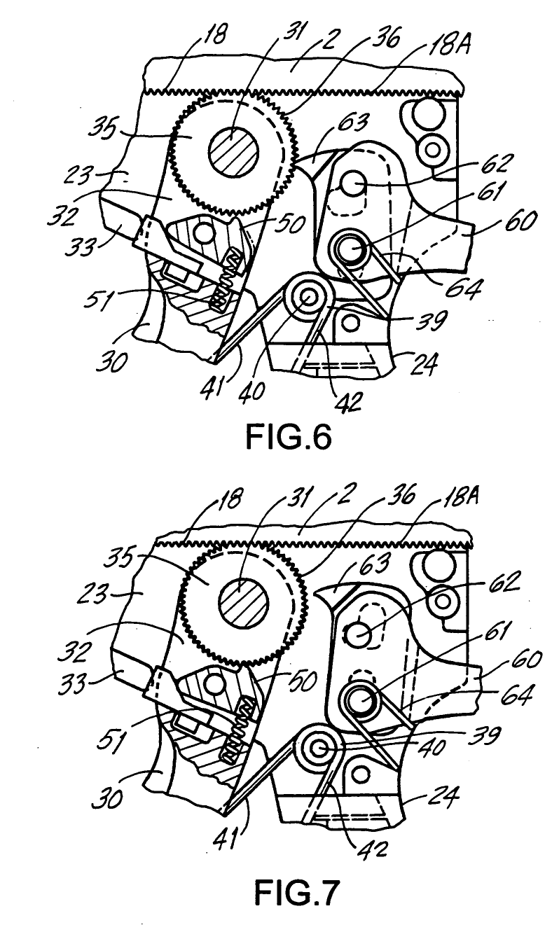

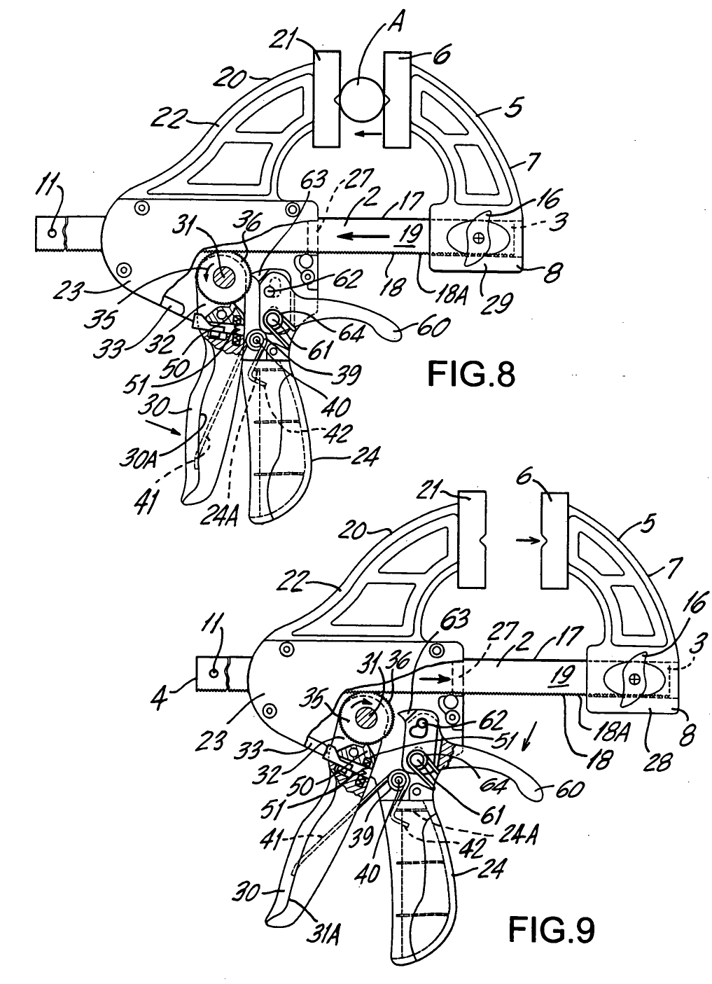

The active head 32 of the trigger 30 as a trigger pawl 50 which is normally biased by spring 51 toward the teeth 36 of the ratchet wheel 35. When the trigger 30 is moved toward the handle 24 against the action of the spring 41, its trigger pawl 50 engages the teeth 36 in the ratchet wheel 35 and rotates the ratchet wheel 35 counterclockwise (FIGS. 6 and 8) to move the jaw assembly 5 in a rearward direction and the jaw 6 toward the jaw 21. Continued squeezing of the trigger 30 across the jaw assemblies 5 and 20 to grasp an article A between them. When the trigger 30 is released the trigger pawl 50 moves away from the ratchet wheel 35 and out of any of its teeth 36.

A release arm 60 is pivotally mounted on the handle 24 on one of the pivot points 61 and 62 and is operatively connected through pivot points 61 and 62 to a release pawl 63 which is biased by spring 64 so that it normally enters a tooth 36 in the ratchet wheel 35 at a point spaced from the point where the trigger pawl 50 engages the ratchet wheel 35. This prevents the ratchet wheel 35 from moving clockwise when the trigger 30 is pressed to move the trigger pawl 50 into engagement with the teeth 36 of ratchet wheel 35 to rotate the ratchet wheel 35 counterclockwise. It thus prevents the bar 2 from moving forward. When the release arm 60 is moved down against the action of the spring 64, the release pawl 63 is moved out of a tooth 36 in the ratchet wheel 35, freeing the ratchet wheel 35 to move clockwise to permit the bar 2 to move toward the front and to move the jaws 6-21 away from each other (FIGS. 7 and 9).

In operation and with the position of the parts as shown in FIGS. 6 and 8, when it is desired to move the jaws 6-21 toward each, squeezing the trigger 30 with one hand will move the trigger pawl 50 into engagement with teeth 36 of ratchet wheel 35 so that it rotates the ratchet wheel 35 counterclockwise and through the intermediation of its teeth 36 and teeth 18A on the bar 2 is moved backward and the jaw assembly 5 is moved toward the jaw assembly 20. In this position the gripping faces 6-21 will grasp an article A. between them. Releasing the trigger 30 moves the trigger pawl 50 out of engagement with the teeth 36 of the ratchet wheel 35. The ratchet wheel 35 is prevented from moving clockwise by the release pawl 63 of release arm 60 acting on another tooth 36 of the ratchet wheel 35. When it is desired to move the jaws 6-21 apart (FIGS. 7 and 9) to release an article A from the grasp of the gripping faces 6-21, the release arm 60 is pressed down with the thumb (or other finger) of the same hand that is holding the handle assembly 24 against pressure of spring 64 in order to cause its release pawl 63 to move away from the teeth 36 of the ratchet wheel 35. This releases the ratchet wheel 35 so that it can rotate clockwise to permit the bar 2 to be moved forward and thereby move the jaw assembly 5 away from the jaw assembly 20. When the release arm 60 is let go, the spring 64 will move the release arm 60 back to its original position and its release pawl 63 back into meshing relationship with the teeth 36 of the ratchet wheel 35 thereby again locking the bar 2 against forward movement.

It will be seen that the jaw assembly 5-20 with their jaws 6-21 can be moved toward each other by one part of the hand e.g. first four fingers and the other part of the hand (e.g. the thumb of the same hand) can then be used to release the jaw assemblies 5-20 for movement in the opposite direction.

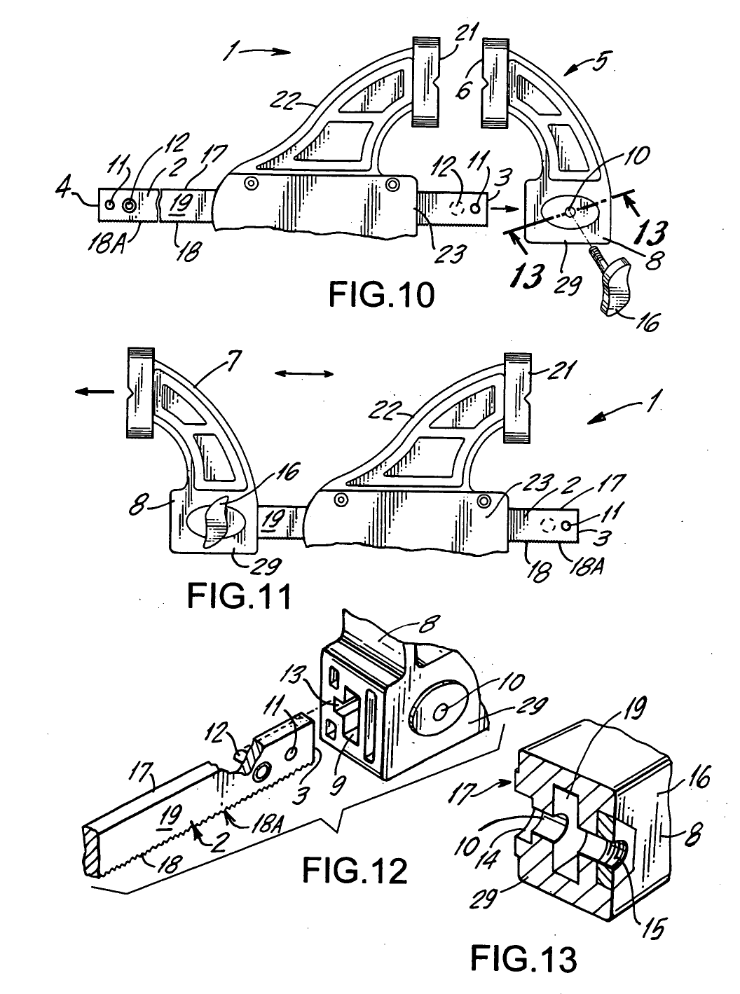

If desired, the jaw assembly 5 of the present invention can be removed from the front end 3 of the bar 2 by unscrewing and removing the wing nut 16 (FIGS. 10-11). The jaw assembly 5 can then be placed on the rear end 4 of the bar 2 by placing the rear end 4 of bar 2 into the opening 9 in the base 8 from its outer end and tightened thereon by the wing nut 16 so that the gripping faces 6-21 face away from each other. In this position, the bar clamp can be used to spread articles apart.

It will thus be seen that the present invention provides an improved bar clamp which is simple to use, in which the jaws can be advanced toward each other with one hand, in which the jaws can be released to move away from each other by the same hand, which is simple and inexpensive to manufacture and in which the jaws can be easily placed in position to spread apart an item as well as to tighten on an item.

As many and varied modifications of the subject matter of this invention will become apparent to those skilled in the art from the detailed description given hereinabove, it will be understood that the present invention is limited only as provided in the claims appended hereto.

The embodiments of the invention in which an exclusive property or privilege is claimed are defined as follows:

1. A bar clamp comprises a first jaw assembly and a second jaw assembly, a bar, said first and second jaw assemblies being mounted on said bar, means for moving said bar relative to the second jaw assembly, a trigger operatively associated with said bar, said moving means comprises bar-engaging means mounted on said trigger to engage said bar to move the bar and the first jaw assembly relative to the second jaw assembly in a first direction, release means on said second jaw assembly operatively associated with said bar-engaging means, said release means adapted to be activated to permit the bar and the first jaw assembly to move relative to the second jaw assembly in a second direction.

2. A bar clamp as set forth in claim 1 wherein bar-engaging means comprises a wheel in engagement with said bar whereby rotation of said wheel will move said bar.

3. A bar clamp as set forth in claim 2 wherein said wheel is a toothed ratchet wheel and wherein said bar has teeth, the teeth of said ratchet wheel being in operative engagement with the teeth on said bar.

4. A bar clamp as set forth in claim 3 wherein said trigger has a trigger pawl, said trigger pawl being movable from a position out of engagement with the teeth of the ratchet wheel to a position into engagement with the teeth of the ratchet wheel.

5. A bar clamp as set forth in claim 4 wherein said trigger is pivotally mounted on said second jaw assembly and wherein said ratchet wheel is mounted on the same pivot.

6. A bar clamp as set forth in claim 5 wherein the trigger being moveable in a predetermined direction to move said trigger pawl into engagement with said teeth in said ratchet wheel to cause the trigger pawl to rotate said ratchet wheel and cause the ratchet wheel to move the bar in said first direction and of the trigger being moveable in the opposite direction will move the trigger pawl out of engagement with the teeth in said ratchet wheel.

7. A bar clamp as set forth in claim 6 wherein spring means are provided to bias said trigger in said predetermined direction.

8. A bar clamp as set forth in claim 7 wherein said release means comprise a release arm pivotally mounted on said second jaw assembly.

9. A bar clamp as set forth in claim 8 wherein said release arm has a release pawl to engage the teeth on said ratchet wheel.

10. A bar clamp as set forth in claim 9 wherein spring means are provided to bias the release pawl into engagement with the teeth on said ratchet wheel whereby pivoting the release arm against the bias of the spring will move the release pawl out of the teeth on the ratchet wheel.

11. A bar clamp as set forth in claim 10 wherein said release pawl engages the teeth on said ratchet wheel at a point spaced from the point where the trigger pawl engages the teeth on said ratchet wheel.

12. A bar clamp as set forth in claim 11 wherein said second jaw assembly has a handle extending therefrom and wherein said release arm is pivotally mounted thereon and wherein said trigger is spaced from said handle and moveable relative to said handle.

13. A bar clamp as set forth in claim 12 wherein spring means are provided to bias said trigger away from said handle.

14. A bar clamp as set forth in claim 13 wherein said first jaw assembly and second jaw assemblies each have a gripping face and a base.

15. A bar clamp as set forth in claim 14 wherein the base of the first jaw assembly and second jaw assembly end has an opening into which one end of the bar is inserted.

16. A bar clamp as said forth in claim 16 wherein said trigger has an active head extending through an opening in a bottom wall of the base in the second jaw assembly.

17. A bar clamp as set forth in claim 16 wherein at least one end of the bar has an opening therein and a pin extending from the bar and wherein the opening in the base of the first jaw assembly has a slot adapted to receive the said pin.

18. A bar clamp as set forth in claim 17 wherein jaw assembly means are adapted to be removably mounted on said bar to removably hold the first jaw assembly on said bar.

19. A bar clamp as set forth in claim 18 wherein an opening is provided in the base of the first jaw assembly, said opening having a threaded portion, and said holding means comprises a threaded member mountable in the opening in the base and through the opening in the bar.

20. A bar clamp as set forth in claim 19 wherein the other end of the bar has an opening and a pin extending therefrom to permit the other end of the bar to receive said first jaw assembly.

21. A bar clamp as set forth in claim 1 wherein said release means comprise a release arm pivotally mounted on said second jaw assembly.

22. A bar clamp as set forth in claim 21 wherein said release arm has a release pawl to engage the teeth on said ratchet wheel.

23. A bar clamp as set forth in claim 22 wherein spring means are provided to bias the release pawl into engagement with the teeth on said ratchet wheel whereby pivoting the release arm against the bias of the spring will move the release pawl out of the teeth on the ratchet wheel.

24. A bar clamp as set forth in claim 23 wherein said release pawl engages the teeth on said ratchet wheel at a point spaced from the point where the trigger pawl engages the teeth on said ratchet wheel.

25. A bar clamp as set forth in claim 24 wherein said second jaw assembly has a handle extending therefrom and wherein said release arm is pivotally mounted thereon and wherein said trigger is spaced from said handle and moveable relative to said handle.

26. A bar clamp as set forth in claim 25 wherein spring means are provided to bias said trigger away from said handle.

27. A bar clamp as set forth in claim 26 wherein said first jaw assembly and second jaw assemblies each have a gripping face and a base.

28. A bar clamp as set forth in claim 27 wherein the base of the first jaw assembly and second jaw assembly end has an opening into which one end of the bar is inserted.

29. A bar clamp as said forth in claim 28 wherein said trigger has an active head extending through an opening in a bottom wall of the base in the second jaw assembly.

30. A bar clamp as set forth in claim 29 wherein at least one end of the bar has an opening therein and a pin extending from the bar and wherein the opening in the base of the first jaw assembly has a slot adapted to receive the said pin.

31. A bar clamp as set forth in claim 30 wherein jaw assembly means are adapted to be removably mounted on said bar to removably hold the first jaw assembly on said bar.

32. A bar clamp as set forth in claim 31 wherein an opening is provided in the base of the first jaw assembly, said opening having a threaded portion, and said holding means comprises a threaded member mountable in the opening in the base and through the opening in the bar.

33. A bar clamp as set forth in claim 32 wherein the other end of the bar has an opening and a pin extending therefrom to permit the other end of the bar to receive said first jaw assembly.
